(19) United States
(12) Patent Application Publication
(10) Pub. No.: US 2009/0277362 A1
(43) Pub. Date: Nov. 12, 2009

(54) Security device for automatic dispensers of banknotes and values

(75) Inventor: Giuseppe Ezio Fumanelli, Melzo (IT)

Correspondence Address: BROWDY AND NEIMARK, P.L.L.C.;624 NINTH STREET, NW, SUITE 300, WASHINGTON, DC, 20001-5303, US

(73) Assignee: M.I.B. S.p.A, Sesto Fiorentino (IT)

(21) Appl. No.: 12/436,540

(22) Filed: May 6, 2009

(30) Foreign Application Priority Data
May 7, 2008 (IT) MI2008A 000817

(51) Int. Cl. E05G 1/026

(52) U.S. Cl. 109/64

(57) ABSTRACT

Provided herein is a security device (1) for automatic dispensers (2) of banknotes and securities (3) including a dispensing slit (4) and conveying means (5) designed to convey the banknotes and securities (3) through the dispensing slit (4) along a transfer path (6). The security device (1) comprises a blocking body (7) that is able to move between a first position of interruption, in which it interrupts the transfer path (5), and a second position of use, in which it is outside the transfer path (6); the blocking body (7) moreover comprises a box-shaped casing (9) including a fire-extinguishing, flame-resistant, and smoke-producing filling substance (10), designed to hinder actions of effraction perpetrated on automatic tellers (2).

### FIELD OF THE INVENTION

The subject of the present invention is a security device for automatic dispensers of banknotes and securities of the type described in the preamble of the first Claim.

### DESCRIPTION OF THE PRIOR ART

Currently known are dispensers of banknotes or securities, such as in particular Bancomats or ATMs (Automatic Teller Machines), or similar machines. They comprise an armoured container designed to contain banknotes and securities and a dispensing slit designed to dispense banknotes or securities. The dispensing mouths hence generally face public areas, are accessible to the users, and have a slit or the like through which the money is passed, usually gathered in wads.

The banknotes or wads of banknotes that pass through said slits are generally moved by means of belt conveyors, set inside the teller.

In particular in the case of Bancomats or ATMs these modes of movement and dispensing of the banknotes are efficient and very widespread.

They present, however, a drawback: they enable introduction of explosive substances through the dispensing slit of the automatic teller.

One of the possible attempts at effraction carried out on armoured casings of automatic dispensers of banknotes and securities envisages in fact that a fluid or in any case an explosive substance may be introduced therein, and this fluid may then made to explode so as to blow said safes open from inside in order to enable access to the banknotes and the securities kept therein.

To overcome this drawback certain apparatuses have been developed, which comprise a mechanical protection barrier designed to prevent introduction of gas within the dispensing slit. Said protection barrier must consequently be lowered at the point where the banknotes and securities are dispensed.

However, also said barrier can be perforated, for example by means of a drill or the like, and even a mere hole enables introduction of explosive substances inside the teller.

The prevention of introduction of foreign bodies, dangerous fluids, or the like, is, however, a technical problem that is difficult to solve.

In fact, in all automatic tellers there has to be allowed convenient passage for the banknotes, and outside the machine the operations of withdrawal or payment made by authorized users must not be hindered or rendered difficult or hard to understand.

### SUMMARY OF THE INVENTION

In this situation, the technical task of the present invention is to devise a security device for automatic dispensers of banknotes and securities that will be able to overcome substantially the drawbacks referred to above.

In the framework of said technical task an important purpose of the invention is to provide a security device that will be able to prevent introduction of explosive substances or the like at the dispensing slit of the tellers.

The technical task and purposes specified are achieved by a security device for automatic dispensers of banknotes for an automatic dispenser of banknotes and securities, including a dispensing slit and conveying means designed to convey the banknotes and securities through the dispensing slit along a transfer path, the security device comprising a blocking body, comprising a box-shaped casing housing a filling substance designed to hinder actions of effraction perpetrated on the automatic dispenser. The security device comprises besides movement means designed to move the blocking body between a first position of interruption, in which the blocking body interrupts the transfer path, and a second position of use, in which the blocking body is outside the transfer path.

### BRIEF DESCRIPTION OF THE DRAWINGS

The attached drawings illustrate by way of example preferred embodiments of the invention. In particular:

FIG. 1 shows a median section of the security device according to the invention in a first operating step; and

FIG. 2 is a median section of the security device in a second operating step.

### DESCRIPTION OF THE PREFERRED EMBODIMENTS

With reference to the figures, the security device according to the invention is designated as a whole by the reference number 1.

It is designed to be included in an automatic dispenser 2 of banknotes and securities 3 preferably constituted by a Bancomat or by an ATM or the like. Said automatic teller 2 comprises, by and large, a safe provided with a slit 4 for dispensing of the banknotes and securities 3, located in public places accessible by authorized users, such as streets, commercial centres, malls, and the like.

The banknotes and securities 3 are thus dispensed through said dispensing slit 4, and appropriate conveying means 5 are designed to convey the banknotes and securities 3 along a transfer path 6.

Said conveying means 5 are, for example, constituted by conveyor belts or the like.

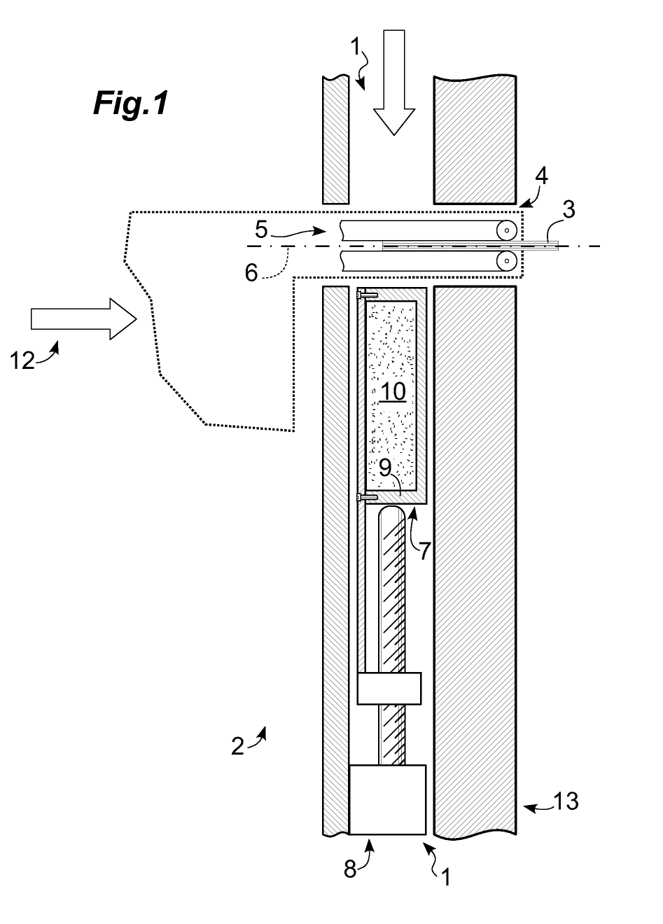

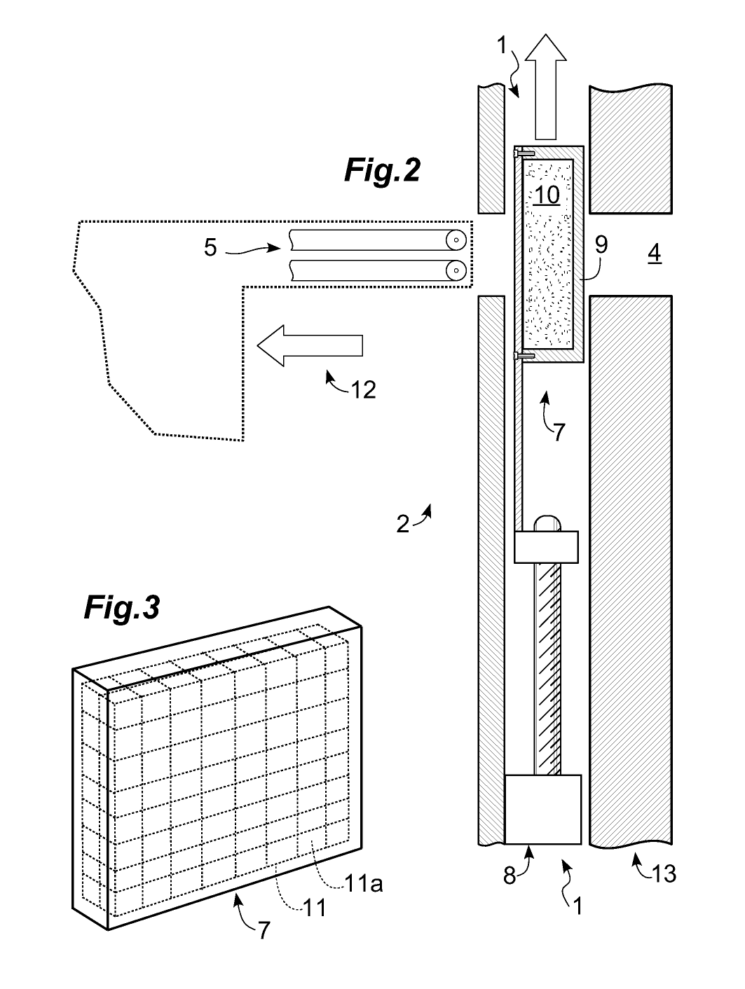

The security device 1 comprises a blocking body 7 and movement means 8 designed to move the blocking body 7 between a position of interruption (FIG. 2) and a position of use (FIG. 1). The movement means 8 are appropriately constituted by a wormscrew activated by an electric motor.

In particular, when the blocking body 7 is set in the position of interruption (FIG. 2) it interrupts the transfer path 5. Instead, when the blocking body 7 is set in a position of use (FIG. 1) it is outside the transfer path 6 and hence does not hinder transfer of banknotes and securities through the dispensing slit 2 and along the path 5.

In order to enable said position of interruption by the blocking body 7, the automatic teller 2 comprises appropriate translation means 12, designed to translate the conveying means 5 between a retracted position (FIG. 2), where they are set at a distance from said dispensing slit 4, and an advanced position (FIG. 1), where they are substantially adjacent to the dispensing slit 4 and hence project outside the teller 1.

The retracted position of the conveying means 5 is obtained preferably in concomitance with the position of interruption of the blocking body 7 and prevents dispensing of banknotes or securities 3 or introduction of any substance through the dispensing slit 4.

Instead, the advanced position of the conveying means 5 is obtained in concomitance with the position of use of the blocking body 7 in such a way that the conveyor belt is set in the proximity of the dispensing slit 4 and the banknotes and securities may be transferred easily.

The blocking body 7 thus prevents, when in it is the position of interruption, insertion of substances in the form powder, gas or liquid within the dispensing slit 4.

It can be positioned within an outer wall 13 of the automatic teller or in a purposely provided housing inside the device itself.

The blocking body 7 is moreover preferably designed to prevent forcing or perforation, via drills or the like, of the blocking body 7 itself.

For this purpose, it comprises a box-shaped casing 9 made of a high-strength metal material, preferably steel including manganese or other high-strength steels.

The box-shaped casing 9 houses inside it a filling substance 10 designed to hinder actions of effraction of the automatic teller 2.

In particular, the filling substance 10 can comprise a self-extinguishing substance preferably constituted by a generator of aerosol, which, when activated thermally at high temperatures, more precisely above 400° C., is able to dispense an extinguishing particulate which can combine chemically with oxygen so as to rule out the capacity of the latter to function as comburent in explosions and fires.

A similar generator of extinguishing aerosol can be in powder form or in the form of blocks and preferably of the type described, for example, in the patent No. EP 0 871 516 filed in the name of Dynamit Nobel GmbH.

The filling substance 10 may moreover comprise a smoke-producing substance, i.e., a substance designed to bring about chemical reactions that give rise to aeriforms, preferably visible at a distance and coloured, for example red.

Also the smoke-producing substances are activated preferably in the presence of high temperatures.

The filling substance 10 can then consist of, or comprise, mere water, which at high temperatures boils and hinders possible actions of effraction and the like. In the latter case, or in the ones mentioned previously, the box-shaped casing 9 preferably comprises a container 11 divided into a plurality of compartments 11a designed to distribute the filling substance 10 and prevent simultaneous activation of the entire volume thereof.

The compartmentalized container 11 is illustrated in FIG. 3 and is preferably made of an impermeable polymeric material or impermeable plastic material, for example polypropylene or polyethylene.

In order to be able to produce the blocking body 7 easily, the box-shaped casing 9 is at least partially closed via bolts or the like.

The device 1 finally comprises sensors designed to detect actions of effraction perpetrated on the automatic teller 2 and in particular on the blocking body 7. The sensor is moreover preferably connected to means for signalling a possible attempt at effraction.

Operation of a security device 1, which has been described above from a structural standpoint, is presented in what follows.

The automatic teller 2 including the security device 1 functions regularly, according to the known art, and dispenses the banknotes or securities 3 to authorized users.

Said conventional operation occurs when the conveying means 5 are in an advanced position and the blocking body 7 is in a position of use, as illustrated in FIG. 2.

Instead, when the automatic teller is not used, or else in particular timetables, or else in concomitance with possible alarms issued by the sensors, the conveying means 5 set themselves in a retracted position, and the blocking body 7 sets itself in a position of interruption, as illustrated in FIG. 1.

In this case, it is not possible to introduce anything through the dispensing slit 4.

If possible thieves were to drill a hole or make a cut into the blocking body 7, the filling substance 10, activated in particular by the high temperature caused by the tools used for effraction, such as drills, oxyhydrogen flame, and the like, would hinder said action of effraction and would issue a warning.

In addition, in the case where the thieves were to manage to perforate the blocking body 7 completely, the self-extinguishing substance present in the filling substance 10 would be activated. In this case, it would hence not be possible to cause explosions inside the automatic teller 2 precisely on account of the activation of the self-extinguishing substance.

The invention affords important advantages.

In fact, the security device 1 prevents, in particular on account of the structure of the blocking body 7, introduction of substances within the automatic teller 2. In addition, the security device 1, on account of the presence of the self-extinguishing aerosol present in the filling substance 10, effectively prevents any phenomenon of explosion within the automatic teller 2.

In the presence of smoke-producing substances, the filling substance 10 moreover signals the presence of an attempt at effraction and alerts the forces of order or causes the thieves to run away.

The security device 1 is moreover very simple, can be positioned within the outer wall 13 of the teller, and is thus economically advantageous and easy to assemble also on pre-existing automatic tellers 2.

The invention may undergo modifications and variations, all of which fall within the framework of the inventive idea. All the items may be replaced by equivalent elements and materials, and the shapes and dimensions may be any whatsoever.

1. A security device (1) for an automatic dispenser (2) of banknotes and securities (3), said automatic dispenser (2) including a dispensing slit (4) and conveying means (5) designed to convey said banknotes and securities (3) through said dispensing slit (4) along a transfer path (6), said security device (1) comprising a blocking body (7), comprising a box-shaped casing (9) housing a filling substance (10) designed to hinder actions of effraction perpetrated on said automatic dispenser (2), and movement means (8) designed to move said blocking body (7) between a first position of interruption, in which said blocking body (7) interrupts said transfer path (6), and a second position of use, in which said blocking body (7) is outside said transfer path (6).

2. The device according to claim 1, in which said filling substance (10) comprises an extinguishing substance that is self-activatable at high temperatures.

3. The device according to claim 1, in which said filling substance (10) comprises a smoke-producing substance that is self-activatable at high temperatures.

4. The device according to claim 1, in which said filling substance (10) comprises water.

5. The device according to claim 1, in which said filling substance (10) defines a compartmentalized container (11) including a plurality of compartments made of impermeable plastic material (11a) designed to contain and present portions of said filling substance (10).

6. The device according to claim 1, comprising sensors designed to detect actions of effraction perpetrated on said automatic dispenser (2).

7. The device according to claim 1, in which said box-shaped casing (9) is made of steel including manganese.

8. An automatic dispenser (2) of banknotes and securities (3) comprising a dispensing slit (4), conveying means (5) designed to convey said banknotes and securities (3) through said dispensing slit (4) along a transfer path (6), and a security device (1) according to claim 1.

9. The dispenser according to claim 8, comprising translation means (12) designed to translate said conveying means (5) between a retracted position, where they are set at a distance from said dispensing slit (4), and an advanced position, where they project substantially outside the dispenser (1), said blocking body (7) in said position of interruption being set between said mouth (4) and said conveying means (5) in said retracted position.

10. The dispenser according to claim 8, comprising an outerwall (13) and in which said security device (1) is set within said outer wall (13).
